(19) United States
(12) Patent Application Publication
(10) Pub. No.: US 2017/0085162 A1
(43) Pub. Date: Mar. 23, 2017

(54) Cage Rotor For An Electric Machine

(71) Applicant: Siemens Aktiengesellschaft, Muenchen (DE)

(72) Inventors: Tabea Arndt, Erlangen (DE); Joerg Grotendorst, Nuernberg (DE); Detlef Potoradi, Bad Neustadt/Saale (Muehlbach) (DE); Markus Reinhard, Ludwigshafen (DE)

(73) Assignee: Siemens Aktiengesellschaft, Muenchen (DE)

(21) Appl. No.: 15/308,426

(22) PCT Filed: Apr. 9, 2015
(86) PCT No.: PCT/EP2015/057692

§ 371 Date: Nov. 2, 2016

(30) Foreign Application Priority Data
May 6, 2014 (DE) 10 2014 208 399.0

(51) Int. Cl. H02K 17/16; H02K 17/18

(52) U.S. Cl. CPC H02K 17/165; H02K 17/185

(57) ABSTRACT

A cage rotor for an electric machine may include a rotor core and an electrically conductive rotor cage arranged around the rotor core, wherein the rotor cage includes carbon nanotubes. An electric machine including such a cage rotor is also disclosed.

### CROSS-REFERENCE TO RELATED APPLICATIONS

This application is a U.S. National Stage Application of International Application No. PCT/EP2015/057692 filed Apr. 9, 2015, which designates the United States of America, and claims priority to DE Application No. 10 2014 208 399.0 filed May 6, 2014, the contents of which are hereby incorporated by reference in their entirety.

### TECHNICAL FIELD

The invention relates to a cage rotor for an electric machine having a rotor core and an electrically conductive rotor cage arranged around the rotor core. The invention further relates to an electric machine having such a cage rotor.

### BACKGROUND

Many electric machines, most particularly three-phase induction machines, are operated using a cage rotor. Such a cage rotor typically has a plurality of longitudinal rods, also referred to as rotor bars, which are electrically connected at the two axial ends of the rotor to so-called short-circuiting rings. The entire cage-like structure of the cage rotor is accordingly electrically short-circuited during the operation of the machine. Such a rotor cage is therefore referred to also as a squirrel cage. This rotor type differs from the so-called slip ring rotor, in which the windings of the rotor are not short-circuited to one another, but are present as separate coil windings and are in each case contacted externally via slip ring contacts.

In known cage rotors, the longitudinal rods of the rotor cage consist of solid metal bars made of nonferrous metals such as copper, aluminum or alloys thereof. Said metal rods are permanently mechanically and electrically connected to short-circuiting rings arranged at the end side, typically by being inserted and soldered into recesses provided for that purpose in the short-circuiting rings. Such a rotor cage is described in EP 1039618A1.

A disadvantage of said known rotor cages or squirrel cages is the high manufacturing and assembly overhead involved in the production of said connections. The rotor cages are exposed to high centrifugal forces during the operation of the electric machines. First and foremost, therefore, the connections must satisfy high mechanical requirements. Often the connections need to be additionally reinforced by means of externally applied bindings, which in turn increases the manufacturing overhead and the space requirements of the rotor. Furthermore, the substantial weight of the metallic rotor bars and the likewise metallic short-circuiting rings has a disadvantageous impact on the level of the centrifugal forces.

In an alternative known embodiment variant, the squirrel cage is produced in a casting process, for example by pressure die casting of aluminum. Such cast rotor cages find application mainly in machines of low and medium power, due to difficulties in scaling to large dimensions.

### SUMMARY

One embodiment provides a cage rotor for an electric machine having a rotor core and an electrically conductive rotor cage arranged around the rotor core, wherein the rotor cage comprises carbon nanotubes.

In one embodiment, the rotor cage comprises fibers which are in each case spun from a plurality of carbon nanotubes.

In one embodiment, the rotor cage comprises at least one element braided or woven from fibers containing carbon nanotubes.

In one embodiment, the rotor cage comprises a plurality of longitudinal rods and two end-side connecting structures which in each case join at least some of the longitudinal rods to one another in an electrically conductive manner.

In one embodiment, the rotor cage comprises one or more rope strands composed of carbon nanotubes.

In one embodiment, the rotor cage has a plurality of longitudinal rods and two end-side connecting structures, wherein at least some of the rope strands extend both over some of the longitudinal rods and over at least one connecting structure.

In one embodiment, the rotor cage has a plurality of longitudinal rods and two end-side connecting structures, wherein the longitudinal rods and the connecting structures are linked to one another by means of knots in the rope strands.

In one embodiment, the rotor core is formed substantially from a soft magnetic material.

In one embodiment, the rotor core has a plurality of slots which accommodate a plurality of longitudinal rods of the rotor cage.

In one embodiment, the rotor cage comprises at least one rope strand formed from carbon nanotubes which is wrapped under initial tension into the slots of the rotor core.

In one embodiment, the rotor cage and the rotor core together form a mechanically self-supporting structure.

In one embodiment, the at least one rope strand of the rotor cage is wrapped into the slots of the rotor cage in multiple layers.

In one embodiment, the rotor cage comprises a braided net having rope strands composed of carbon nanotubes, wherein the net is wound around the rotor core.

In one embodiment, the rotor cage comprises at least one textile mat consisting of fibers of carbon nanotubes which is provided with cutouts and is wound around the rotor core.

Another embodiment provides an electric machine having a cage rotor as disclosed above.

### BRIEF DESCRIPTION OF THE DRAWINGS

Example aspects and embodiments of the invention are described with reference to the attached drawings, in which:

FIG. 1 shows a schematic perspective view of a cage rotor according to a first exemplary embodiment,

FIG. 2 shows a schematic perspective view of a solid rotor core according to a second exemplary embodiment,

FIG. 3 shows a schematic plan view of a mat suitable for wrapping around the rotor core shown in FIG. 2,

FIG. 4 shows a cross-section of two slots in the rotor core according to a third exemplary embodiment,

FIG. 5 shows a cross-section of two slots in the rotor core according to a fourth exemplary embodiment,

FIG. 6 shows a cross-section of two slots in the rotor core according to a fifth exemplary embodiment,

FIG. 7 shows a schematic representation of the electrical connection of the longitudinal rods according to a sixth exemplary embodiment, and

FIG. 8 shows a schematic representation of an alternative electrical connection according to a seventh exemplary embodiment.

### DETAILED DESCRIPTION

Embodiments of the invention provide a cage rotor having a rotor cage which avoids the cited disadvantages. In particular it is aimed to disclose a rotor cage that is simple and cost-effective to produce and is also available for large rotor dimensions.

The cage rotor may have a rotor core and an electrically conductive rotor cage arranged around the rotor core, the rotor cage comprising carbon nanotubes. In particular the rotor cage is configured in such a way in this arrangement that a substantial part of the electric current flowing in the rotor cage during the operation of the machine is transported by means of the carbon nanotubes.

One advantage of the disclosed cage rotor lies in the ease of its production. Electrically conductive cage structures for the cage rotor can be realized in a simple manner, in particular with the embodiment variants described further below having the fibers, yarns, ropes and mats based on carbon nanotubes. In this case the geometry of the cage structure can be flexibly adapted to suit different motor types, since there is no requirement for prefabricated rods, rings or other rigid parts having the specific geometry of the rotor cage.

A further advantage lies in the fact that a squirrel cage based on carbon nanotubes can have a comparatively small mass. For example, the density of compressed fibers composed of carbon nanotubes can lie between 0.5 and 1.5 g/cm³. Given comparable current carrying capacity, this enables the use of electrically conductive elements having lower mass than would be possible in the case of a metallic element. Accordingly, the centrifugal forces occurring during the operation of the electric machine also prove to be less, and the mechanical stresses imposed on the components are correspondingly lower. The electric machine can therefore also be operated at higher rotational speeds than when known cage rotors are used.

Furthermore, materials based on carbon nanotubes possess good electrical conductivity, mechanical load-bearing capability and chemical resistance. The mechanical load-bearing capability and the electrical conductivity of individual carbon nanotubes exceed by a multiple values for metals and metallic alloys. Even if macroscopic components having fibers or yarns composed of carbon nanotubes do not attain the values for the individual tubes, the values for conductivity and load-bearing capability could nonetheless be considerably increased by means of new manufacturing methods. For example, spun fibers composed of carbon nanotubes having specific resistances between 22 and 33 μOhm·cm are described by N. Behabtu et al. (N. Behabtu et al. in Science 339 (2013), pp. 182-185). Although the electrical conductivity of said materials is not yet as high as that of copper and its alloys, the mechanical strength is nonetheless already superior in part to that of highly conductive metallic alloys. Moduli of elasticity above 100 GPa and tensile strengths in the range of 1 GPa have been measured for fiber thicknesses in the range between 8 and 10 μm. Even if said values still lie in similar ranges to those of materials containing copper, a particular advantage of the carbon nanotubes is to be seen in the fact that their conductivity and their mechanical load-bearing capability are not detrimentally affected to any significant extent even in the event of the fibers being kinked or the components being bent out of shape. However, such robustness in the case of a bend in a conductor guide is of particular advantage precisely when used for the cage structure of a rotor cage.

In some embodiments, the cage rotor can additionally have one or more of the following features:

The rotor cage can comprise fibers which are in each case spun from a plurality of carbon nanotubes. This embodiment variant is advantageous because individual carbon nanotubes are generally not long enough, not conductive enough and/or not mechanically loadable enough for macroscopic applications. By arranging a large number of carbon nanotubes in a common fiber it is possible to provide a bigger electrical conductor that is better able to fulfill the mechanical, electrical and geometric requirements than a single tube. In many cases it can be advantageous to employ a multiplicity of such fibers in order to achieve predefined values for current carrying capacities, mechanical load-bearing capability and geometric dimensions in a macroscopic component.

The fibers can be obtained either by solid-state spinning or by liquid-state spinning and assembled from a large number of carbon nanotubes. In this case the average diameter of the individual fibers advantageously lies between 5 and 50 μm, particularly advantageously between 5 and 25 μm. The length of the individual carbon nanotubes on which the fiber is based can advantageously lie above 3 μm on average. Particularly advantageously, the average tube length can far exceed this value, lying above 100 μm or even above 1 mm for example. As described in the above-cited Science article by Behabtu et al., high mechanical strengths and good conductivities could, however, also be achieved using fibers composed of tubes having lengths between 3 μm and 11 μm.

In the case of a rotor cage having strongly arcuate sections, in particular having knots in the vicinity of connecting points, the individual fibers can advantageously likewise be arranged with a bend or even kinked. The advantage of such an embodiment variant is that fibers composed of carbon nanotubes exhibit scarcely any deterioration in their electrical conductivity even in the bent and/or kinked state.

The fibers containing carbon nanotubes can have an average tear resistance of at least 1 GPa. An electrically conductive element capable of withstanding the high mechanical loads in the rotor of an electric machine can be provided in particular by bundling many of such fibers into one or more larger component parts. In this way the failure resistance of the machine can be improved; in particular, mechanical damage in a kinked section and/or at a connecting point between different elements of the cage structure can advantageously be avoided.

The fibers can have an average modulus of elasticity of at least 50 GPa, particularly advantageously at least 100 GPa, in order to ensure a high mechanical load-bearing capability of the rotor cage.

The specific electrical resistance of the fibers containing carbon nanotubes can lie on average below 1000 μOhm·cm, particularly advantageously below 100 μOhm·cm. Given comparable conductor dimensions, the use of such a fiber material enables current carrying capacities to be achieved that are at least similar to those when metallic alloys are used. In principle it is advantageously also possible to achieve substantially higher conductivities with specific resistances below 10 μOhm·cm, particularly advantageously below 1 μOhm·cm, using materials containing carbon nanotubes.

The density of the fibers containing carbon nanotubes can advantageously lie below 1.5 g/cm³ on average. In the case of compressed fiber materials it particularly advantageously lies between 0.5 and 1.5 g/cm³. Particularly good electrical conductivity and mechanical strength can be achieved as a result of the compression to such values. In spite of this, the density in this range is still significantly less than the density of metallic materials, which means that lower centrifugal forces, and consequently lower mechanical stresses, occur owing to the lower weight for comparable dimensions.

The fibers containing carbon nanotubes can be produced particularly advantageously with application of a tensile stress. Fibers produced in this way can be particularly robust with regard to further mechanical loading and can also exhibit an improved conductivity, in particular in the direction of the tensile load. The fibers can be dried under tensile load, for example. The basic shape of the fibers that is present prior to the drying process can in this case be produced either with or without the presence of a tensile load.

The carbon nanotubes of the rotor cage can be subjected to iodine doping. A substantial increase in electrical conductivity can be achieved as a result of such a doping, at the same time as very high mechanical load-bearing capability.

The individual carbon nanotubes of the rotor cage can be present as single-walled tubes, as multiwalled tubes or as a mix of both these tube types. The number of walls of a tube can advantageously lie between 1 and 5 on average.

The diameter of the individual carbon nanotubes of the rotor cage can advantageously lie between 1 and 6 nm on average.

The rotor cage can comprise at least one element braided or woven from fibers containing carbon nanotubes. In particular, the rotor cage can have at least one stranded wire, one rope, one flat conductor and/or one mat composed of fibers containing carbon nanotubes. In other words, the rotor cage can contain a textile element formed from a plurality of fibers. Such an embodiment variant is particularly advantageous because the rotor cage can then be formed in a simple and cost-effective manner by wrapping, tying and/or braiding the textile material around the rotor core. Particularly advantageously, the textile material containing carbon nanotubes has an at least partially reversible deformability, such that it can be wound around the rotor core with an initial tension. In this case the textile material can also have arcuate and/or kinked sections, e.g. a plurality of sections can be joined to one another by means of knots.

The rotor cage can comprise a plurality of longitudinal rods and at least two end-side connecting structures which in each case join at least some of the longitudinal rods to one another in an electrically conductive manner. In this exemplary embodiment, the longitudinal rods correspond to the rigid rotor bars (or short-circuiting bars) of known cage rotors. In contrast to these, however, the longitudinal rods do not have to be rigid. They are formed from a material containing carbon nanotubes and particularly advantageously contain fibers containing carbon nanotubes. They can therefore be embodied as flexible or at least partially flexible conductor strands.

The longitudinal rods can be aligned parallel to the direction of the axis of rotation of the rotor. For example, they can all be arranged in parallel on a cylindrical surface corresponding to the outer surface of the rotor core.

Alternatively, the longitudinal rods can also be arranged at a slight angle to the axis of rotation. The starting conditions of the electric machine can be improved as a result of such a slightly inclined orientation. For example, the so-called magnetic hum, fluctuations in torque, stray magnetic fields, jarring forces and/or cogging can be reduced. In such an embodiment variant the longitudinal rods no longer lie exactly parallel to one another, but are inclined in different directions, albeit advantageously by an identical angle with respect to the axis of rotation of the rotor. Such a configuration is also referred to as “single cage” crisscross arrangement. Alternatively, in a “double cage” or “multiple cage” embodiment variant, different axial sections of the longitudinal rods can be embodied with different inclinations with respect to the axis of rotation. This alternate crisscrossing is referred in technical circles alternatively also as canting or twisting. The angle of the longitudinal rods with the axis of rotation can amount to up to +/−20 degrees, for example. Particularly advantageously, the angle for a given number of slots n of the stator winding lies at a value of approximately 360°/n.

At least in the axial end sections of the rotor, the longitudinal rods can be electrically connected to ring-shaped structures such that an overall short-circuited cage structure is produced from the rods. The connecting structures then correspond to the short-circuiting rings in conventional squirrel cages. In addition, further connecting structures can also be provided on sections located axially further inward.

In an alternative embodiment not all of the longitudinal rods are connected to one another in a ring shape by means of the connecting structures. For example, only a subset of the longitudinal rods may be linked to one another in an electrically conductive manner by means of each of the at least two connecting structures, so that more complex cage structures can be formed having for example a plurality of partial cages and/or serial electrical connections between the individual longitudinal rods.

The rotor cage can comprise one or more rope strands formed from carbon nanotubes. Particularly advantageously, at least the longitudinal rods of the rotor cage are then substantially formed from such rope strands. In this case each longitudinal rod can comprise either just one or else a plurality of rope strands. In addition, the ring-shaped connecting structures can also advantageously be formed from rope strands containing carbon nanotubes.

In some embodiments, at least some of the rope strands can then extend both over some of the longitudinal rods and over at least one connecting structure. In other words, longitudinal rods and connecting structures can be formed at least in part from the same continuous strands and as a result transition into one another. The forming of an additional electrical connection between separate conductor parts, such as by means of a soldering process for example, can advantageously be avoided as a result.

The superordinate structure of the rotor cage can particularly advantageously be formed substantially by means of interconnected rope strands containing carbon nanotubes. This is particularly advantageous with regard to mechanical robustness and electrical conductivity, because then no subsequent conductive connections need to be created at the transition points between longitudinal rods and connecting rings. The rotor cage can therefore be tied together as a superordinate structure composed of one or more rope strands, said structure being easy to produce and mechanically very stable. In particular, different geometries of the rotor cage can be linked together from rope strands of similar type for different rotor dimensions, without specially configured rods, rings and other adapted prefabricated components being required as in the case of conventional rotor cages.

The sections of the longitudinal rods and connecting structures of the rotor cage can advantageously be linked to one another by means of knots in the rope strands. The connecting structures are in the form of short-circuiting rings which are in each case connected to the ends of all the longitudinal rods. At each connecting point between longitudinal rod and short-circuiting ring there is therefore a three-way connection which can easily be produced by way of a knot. Alternatively, the rope strands can also be wound around one another at the connecting points without a knot in the true sense of the term being formed. In both cases the rope strands are strongly kinked or at least bent. In fibers based on carbon nanotubes, however, this leads at most to a very slight change to the electrical and mechanical properties.

The rotor core can be formed substantially from a soft magnetic material, in particular from a material containing iron in order to guide the magnetic flux. As in the case of conventional cage rotors, the rotor core can be assembled from a plurality of sheet metal laminations stacked in the axial direction. Alternatively, however, it can also be formed from a soft magnetic solid body.

The rotor core can have a plurality of slots which accommodate a plurality of longitudinal rods of the rotor cage. Particularly advantageously, the rope strands of the rotor cage containing carbon nanotubes can then be wrapped or fastened into said slots. Alternatively or in addition, slots for the connecting structures, in particular ring-shaped connecting structures, can also be provided in the axial end sections. Slots for retaining and guiding the various segments of the rotor cage can be provided both in the case of a solid rotor core and in the case of a laminated rotor core.

In particular with the embodiment variant having slots in the rotor core, it is advantageous if the rotor cage comprises at least one rope strand formed from carbon nanotubes which is wrapped under initial tension into the slots of the rotor core. In the case of this embodiment variant the initial tension can be chosen such that the rotor cage and the rotor core together form a mechanically self-supporting structure. Then no additional bindings are required in order to hold the rotor cage in a mechanically stable manner on the body of the rotor core. The initial tension can be chosen such that the rotor cage remains inherently stable on the rotor core even at high rotational speeds during the operation of the electric machine. Even with an embodiment variant having a lamination stack as rotor core, the tension of the rope strands forming the rotor cage can be chosen great enough to ensure that the laminations are held together by means of the rotor cage. In other words, the rotor cage can then also take on the function of a rotor thrust washer known from the prior art, by means of which the lamination stack is normally fixed.

Both the end-side connecting structures and the longitudinal rods can be arranged around the rotor core under tension. Said tension can also be used to achieve a predetermined conductivity of the rope strands, since in the case of fibers based on carbon nanotubes the conductivity in the longitudinal direction is dependent on an applied tensile stress.

The at least one rope strand of the rotor cage can be wrapped into the slots of the rotor cage in multiple layers. In other words, each longitudinal rod can then be formed from a plurality of coils of the rope strand or rope strands. With this embodiment variant it is also possible to achieve more complex cross-sectional shapes of the longitudinal rods in a particularly simple manner by suitable shaping of the cross-section of the slots. In addition to simple circular, semicircular or U-shaped cross-sections, longitudinal rods with rectangular cross-sections or cross-sections composed in stages from several rectangles can also be achieved in this way. Furthermore, the slots, and consequently the longitudinal rods arranged therein, can have for example a cross-sectional shape that conically increases in size in a radially outward direction. They can open up toward the outer wall of the rotor core, or alternatively the opening can narrow toward the outer wall. By means of the shape of the slots it is also possible to form more elaborate cross-sectional shapes, such as e.g. composite shapes having a plurality of longitudinal rods, possibly connected by means of leakage bridges, for each angular position.

In the case of a rotor cage wound in a single layer, on the other hand, the cross-section of a longitudinal rod corresponds to the cross-section of a rope strand, i.e. in the simplest case to the cross-section of a substantially symmetric stranded wire bundle and/or an approximately circular cross-section. Instead of an approximately rotationally symmetric rope, however, it is also generally possible to use a flat ribbon based on carbon nanotubes or a stack of such flat ribbons. In that event the longitudinal rods have approximately the cross-section of a flat rectangle.

The rotor cage may comprise a net having rope strands composed of carbon nanotubes, said net being wound around the rotor core. In particular, this can be a prefabricated braided net which is then wound onto the rotor core around the axis of rotation. If only one layer is wound, longitudinal rods each comprising one rope strand can be formed in this way, or structures having a plurality of rope strands can be formed in each slot by multilayer winding. After the circumferential winding has been completed, the different layers of the net-like winding can be joined to one another for example by interlacing by means of knots.

In the simplest case, such a prefabricated net can have a single series of longitudinal rods between two lateral connecting ropes. In other words, said net can be constructed in the manner of a simple rope ladder in which the rungs too are braided from rope strands. If the distances between said rungs or longitudinal rods are matched to the distances of the slots, such a prebraided net can be wound onto the rotor core in particular with a predetermined tension, and the desired cage structure composed of carbon nanotube rope is produced.

In order to produce more complex cage structures, more elaborate nets can also be braided from such rope strands. For example, the longitudinal rods can additionally be connected by way of further internal connecting strands, which form internal connecting rings after the net has been wound on. Corresponding slots are then beneficially incorporated on the rotor core for such internal connecting rings also. In this embodiment variant the prebraided net then resembles a fishing net having a plurality of meshes adjacent to one another.

The described method also enables more complex cage structures, for example single-cage or multi-cage crisscross assemblies, to be produced in which the longitudinal rods are arranged at a predefined angle to the axis of rotation of the rotor. These angles can then be predefined by means of a corresponding angle of the slots of the rotor core and/or by means of angles in the prefabricated net that is to be wound on.

Alternatively to a braided net, the rotor cage can also be fabricated from a textile mat having fibers composed of carbon nanotubes. To that end, the mat can be provided with cutouts, wherein once again there remains a lattice-like structure having a plurality of longitudinal bridges and at least two end-side transverse bridges. Said lattice-like mat can then be wound in turn onto the rotor core around the axis of rotation, the longitudinal bridges then beneficially coming to lie in turn in slots of the rotor core. The cutouts can be formed by die cutting, for example.

Advantages of the electric machine according to the invention will become apparent analogously to the described advantages of the cage rotor. The electric machine can in this case be either a motor or a generator. Particularly advantageously it can be an induction machine.

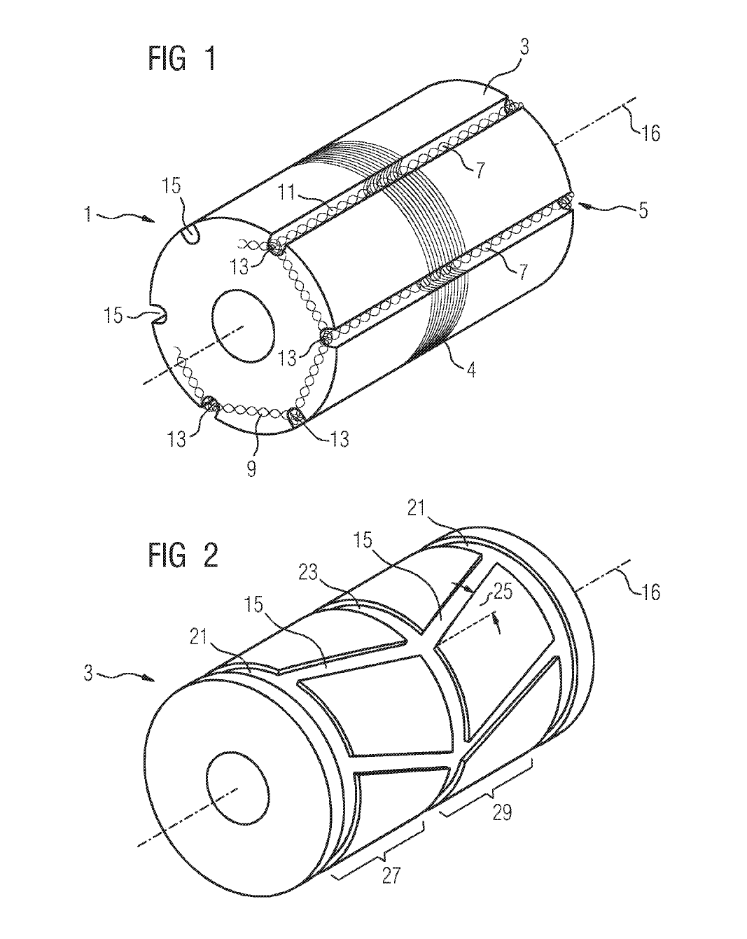

FIG. 1 shows a schematic perspective view of a cage rotor 1 according to a first exemplary embodiment of the invention. A rotor core 3 having a substantially circular cylindrical basic shape is shown, wherein the central axis of the cylinder corresponds to the axis of rotation 16 of the rotor 1 during its operation in an electric machine. As schematically indicated in the central section, the rotor core 3 is formed over its entire axial length from a stack of iron laminations 4. The iron laminations 4 have substantially the basic shape of circular disks and are provided with indentations in their edge regions. The indentations are aligned with respect to one another in such a way that slots 15 extending over the entire rotor core 3 are formed which in this example are aligned substantially parallel to the axis of rotation 16.

The thus constructed rotor core 3 is enveloped by a net of intertwined rope strands 11 such that said net forms a rotor cage 5 enclosing the rotor core 3. The rotor cage 5 has a plurality of longitudinal rods 7 which are inserted into the elongate slots 15. At its axial end sides, the rotor cage 5 additionally has two ring-shaped connecting structures 9 which connect the end sections of the longitudinal rods 7 to one another on each of the two sides.

The rope strands 11 forming the rotor cage 5 are formed from fibers containing carbon nanotubes. The rope strands 11 therefore possess a high electrical conductivity, and the rotor cage 5 is electrically short-circuited over its entire structure. Instead of the relatively coarse rope structure having few stranded wires schematically indicated in FIG. 1, other much more complex and/or finer rope or yarn types can also be used in this case. Each rope strand 11 can in this case comprise a plurality of partial strands. In this case the slots 15 can be shaped to achieve a more complex cross-sectional shape which departs from the approximately rotationally symmetric shape of a simple rope strand.

In the exemplary embodiment shown, the longitudinal rods 7 are joined in each case at their two ends to the ring-shaped connecting structures 9 by means of knots 13. In this case either a plurality of different rope strands 11 can be braided into a concatenated arrangement or the entire network of the rotor cage 5 can be braided from a single continuous rope strand 11. During the production of the cage rotor 1, the net on which the rotor cage 5 is based can be present as a prefabricated net in the manner of a rope ladder consisting completely of rope material and can then be wound in this form around the rotor core 3. In this case a plurality of loops of the net can also be formed around the rotor core such that a plurality of longitudinal rods 7 come to rest in each slot 15. For the loops located further outward, the distance between the fastened longitudinal rods can be increased for this purpose. Alternatively, however, the net can also be tied symmetrically, and the greater distance required for layers lying radially further outward can be achieved by means of the stretchability of the rope strands 11 forming the connecting structure 9.

The rotor cage 5 can be wound or braided around the rotor core 3 under tension such that the rotor core 3 together with its enclosing rotor cage 5 can form a mechanically inherently stable structure. In other words, the cage braided around the rotor core 3 can retain the sheets of the lamination stack on top of one another in a mechanically fixed manner. The tension on the rope strands 11 can be chosen to be sufficiently high in order to withstand the mechanical stresses due to the centrifugal forces generated at high rotational speeds of an electric machine.

For clarity of illustration reasons, only a part of the front ring-shaped connecting structure 9 is shown in FIG. 1 and only some of the slots 15 are filled with the longitudinal rods 7. This serves merely to show the slots 15 of the rotor core 3 more clearly. In an assembled rotor 1 in the finished state, all of the slots 15 are intended to be filled by longitudinal rods 7 and the connecting structures 9 are intended to form annular closed conductors on both sides. A rotor cage 5 having only six longitudinal rods 7 is indicated schematically in FIG. 1. This number is also intended to stand by way of example for a significantly higher number of longitudinal conductors. In real-world electric machines, rotor cages having for example between 10 and 50 longitudinal conductors can be used. Furthermore, the longitudinal conductors 7 can also be arranged at an angle to the axis of rotation, for example in a single-cage crisscross or double-cage crisscross configuration.

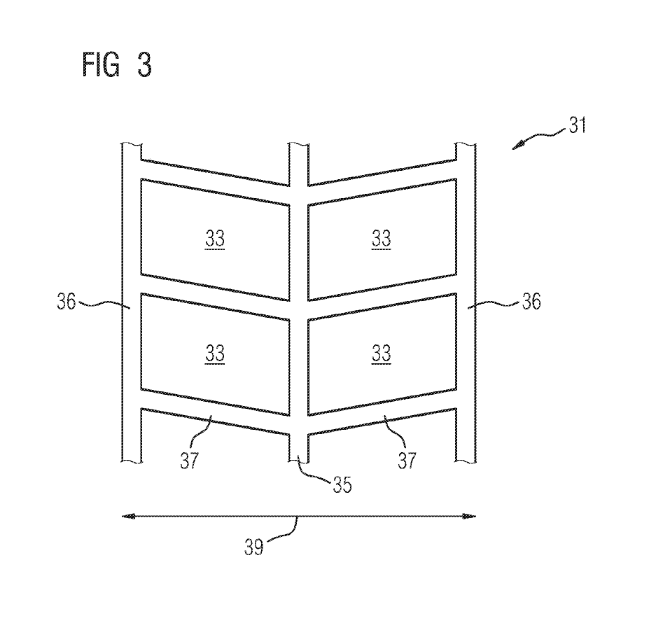

FIG. 2 shows a schematic perspective view of a rotor core 3 which is provided for a cage rotor 1 according to a second exemplary embodiment of the invention. In this example the rotor core 3 is not assembled from sheet metal laminations, but instead is a solid body made of soft magnetic iron. The circular cylindrical basic body is provided with slots into which the structure of a matching rotor cage 5 can be inserted. The structure of a lattice-shaped mat 31 suited to said rotor core 3 is shown as a detail in FIG. 3.

The rotor core 3 shown in FIG. 2 has both slots 15 for the longitudinal rods 7 of the rotor cage and two ring-shaped end-side slots 21 for the ring-shaped connecting structures 9 of the rotor cage and in addition a ring-shaped central slot 23 for a central bridge 35 of the lattice-shaped mat 31 to be wrapped on. In this second exemplary embodiment, the slots 15 for the longitudinal rods 7 are not aligned exactly parallel to the axis of rotation, but are arranged at a slight angle in a double-cage crisscross configuration: In a first radial section 27 the slots 15 are angled circumferentially in a direction counter to the axis of rotation 16, and in a second radial section 29 they are angled circumferentially in a reverse direction counter to the axis of rotation 16. This results in an improved starting behavior of the cage rotor 1 during its operation in an electric machine.

The mat 31 shown in FIG. 3 is formed from fibers which in turn contain carbon nanotubes. For example, the fibers on which the mat is based can mainly be assembled from carbon nanotubes. This makes the entire lattice structure of the mat 31 electrically conductive. Accordingly, when the mat 31 shown is wrapped into the slots 15, and 23 of the rotor core 3, an electrically conductive and inherently short-circuited cage structure is produced. To that end, the end sections of the mat can additionally be joined to one another in an electrically conductive manner, thus producing an electrically closed cylindrical cage.

Matching the angled structure of the slots 15 in FIG. 2, the mat 31 has a fishbone-like structure composed of two sets of inversely inclined longitudinal bridges 37. Located between said two sets of longitudinal bridges 37 is a central bridge 35 which is inserted into the central slot 23 of the rotor core 3. Located at the sides of the lattice structure are two lateral bridges 36 which are inserted into the ring-shaped end-side slots 21. Similarly to the rope net from the first exemplary embodiment, the lattice-like mat can be wound around the rotor core 3 either in one layer or in multiple layers. In this case a rotor cage 5 is then produced having either single-layer or multilayer longitudinal rods 7.

Only a detail of a much longer web of the lattice-like mat 31 is shown in FIG. 3. Such mats 31 can be provided for example on a supply roll and can be wound around the rotor core 3 under a tensile stress during the production of the cage rotor 1. The width of the mat web 39 corresponds in this case to the axial length of the rotor cage that is to be formed.

The lattice-like mat 31 can be formed for example from a textile web of large surface area by die stamping or by cutting out the required cutouts 33. A felt-like planar mat is particularly suitable for such a method. Alternatively, the mat 31 can also be woven, braided, knitted or produced in some other way from fibers based on carbon nanotubes simultaneously with the required lattice structure.

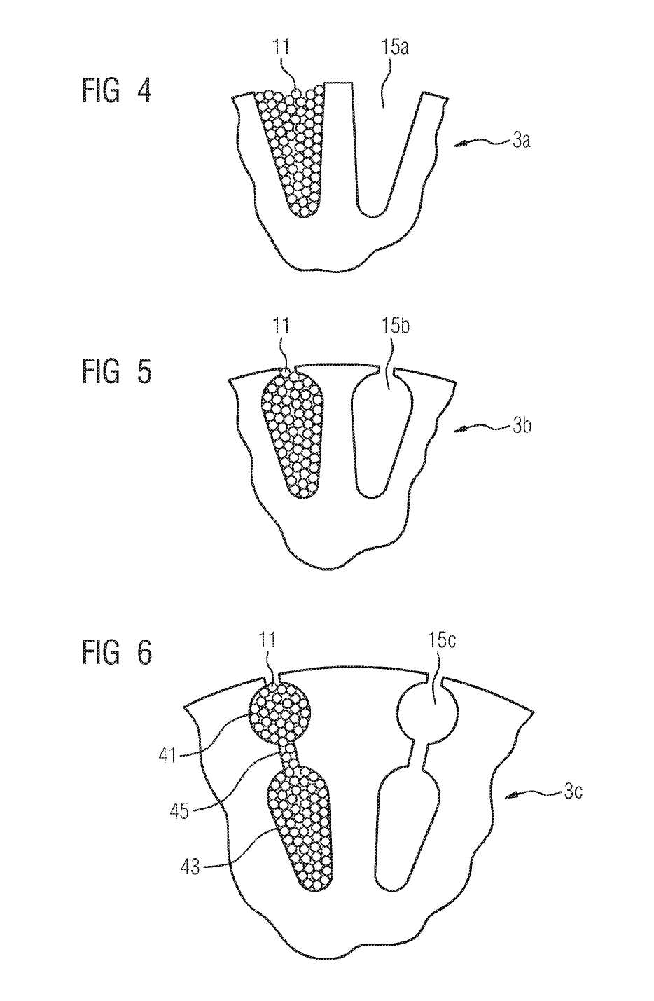

FIG. 4 shows a detail of two slots 15a in a rotor core 3a according to a third exemplary embodiment of the invention. The figure shows a schematic cross-section from which the profile of the slots 15a and therefore the cross-sectional shape of the longitudinal rods 7 formed by rope strands 11 embedded in the slots 15a can be seen. In this case the left-hand slot of the two slots 15a shown is depicted by way of example already filled with rope strands 11, and the right-hand slot of the two slots 15a is depicted still empty. In this example the slots 15a open up radially outwardly toward the surface of the rotor core 3a, with the result that externally a greater conductor cross-section of the longitudinal rod 7 formed from the rope strands 11 is produced.

An alternative fourth exemplary embodiment hereto is shown schematically in FIG. 5. This figure also depicts two slots 15b in a rotor core 3b, wherein once again the left of the two slots 15b is shown filled with rope strands 11 by way of example. In this case too, the slots 15b initially open up conically toward the outside such that the cross-section of the conductor strands is enlarged toward the outside. Close to the surface of the rotor core 3b, however, the opening of the slots 15b is narrowed.

FIG. 6 shows a further exemplary embodiment in which the slots 15c of the rotor core 3c are formed in each case from two larger partial openings which are connected to one another by means of a narrow bridge. By inserting rope strands 11 into said complex-shaped slots, a longitudinal rod 7 is formed in each slot, which longitudinal rod 7 in turn comprises an upper rod 41, a lower rod 43 and a leakage bridge 45 connecting said two partial rods.

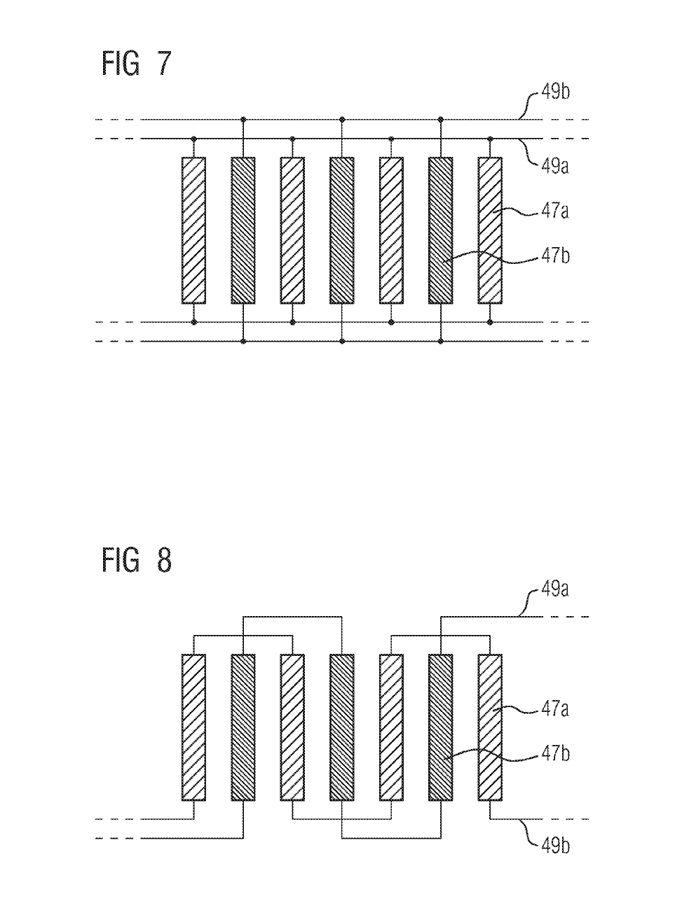

FIG. 7 shows a schematic representation of the electrical connection of the longitudinal rods 47a and 47b of a cage rotor 1 according to a sixth exemplary embodiment of the invention. In this exemplary embodiment, the longitudinal rods 47a and 47b are not all annularly connected to one another at the two end sides, but instead the connecting structures are embodied in such a way that two nested partial cages 49a and 49b are formed. For this purpose, two connecting structures are provided at each axial end of the cage rotor 1, these being represented in FIG. 7 by the two electrical connections extending at top and bottom. Each of said connecting lines links every second one of the longitudinal rods to one another in such a way that two electrically independent partial cages 49a and 49b of the cage rotor are formed in each case from two electrically separate sets of longitudinal rods 47a and 47b. An advantage of such a configuration can reside among other things in the fact that a higher inclination of the longitudinal rods 47a and 47b can be formed for each of the partial cages 49a and 49b.

An alternative example of an electrical connection of the longitudinal rods 47a and 47b is shown in FIG. 8. In this case too, the longitudinal rods form two subsets 47a and 47b which are electrically independent of one another and are connected to one another in each case to form two partial cages 49a and 49b. In contrast to the previous example, however, the longitudinal rods 47a, 47b in the partial cages 49a, 49b are connected to one another, not in parallel, but serially. The two pairs of end-side connecting structures are to that end not embodied as annularly closed connections, but instead there exists within a partial cage 49a or 49b on each of the two end sides in alternation a connection between the associated longitudinal rods 47a or 47b of a partial cage 49a or 49b.

In similar fashion it is also possible to form serially connected cage structures having only one superordinate cage instead of two or more partial cages. A plurality of different configurations are conceivable, since in the first place the number of partial cages can be varied and in the second place combinations of longitudinal rods connected serially and in parallel can also be present within each partial cage. The cage rotors according to the present invention are in any event particularly well suited for embodying such more complex structures, since such nested cage structures can be formed particularly easily precisely as a result of the interlinking of textile structures, for example by the knotting together of rope strands. Cage rotors having at least partially serially linked longitudinal rods can particularly advantageously find application in electric machines having tooth coil concentrated windings in the stator.

What is claimed is:

1. A cage rotor for an electric machine, the case rotor comprising:
a rotor core; and
an electrically conductive rotor cage arranged around the rotor core;
wherein the rotor cage (5) comprises fibers spun from a plurality of carbon nanotubes; and
wherein the rotor cage comprises at least one element woven from fibers including carbon nanotubes or at least one rope strand formed from fibers including carbon nanotubes.

2-3. (cancelled)

4. The cage rotor of claim 1, wherein the rotor cage comprises a plurality of longitudinal rods and two end-side connecting structures,
wherein each end-side connection structure joins at least some of the longitudinal rods to one another in an electrically conductive manner.

5. The cage rotor of claim 1, wherein the rotor cage comprises a plurality of rope strands formed from carbon nanotubes.

6. The cage rotor claim 5, wherein the rotor cage has a plurality of longitudinal rods and two end-side connecting structures,
wherein at least some of the rope strands extend over some of the longitudinal rods and over at least one connecting structure.

7. The cage rotor of claim 5, wherein the rotor cage has a plurality of longitudinal rods and two end-side connecting structures,
wherein the longitudinal rods and the connecting structures are linked to one another by knots in the rope strands.

8. The cage rotor of claim 1, wherein the rotor core comprises a soft magnetic material.

9. The cage rotor of claim 1, wherein the rotor core has a plurality of slots that receive a plurality of longitudinal rods of the rotor cage.

10. The cage rotor of claim 9, wherein the rotor cage comprises at least one rope strand formed from carbon nanotubes, wherein the at least one rope strand is wrapped under initial tension into the slots of the rotor core.

11. The cage rotor of claim 10, wherein the rotor cage and the rotor core together form a mechanically self-supporting structure.

12. The cage rotor of claim 10, wherein the at least one rope strand of the rotor cage is wrapped into the slots of the rotor cage in multiple layers.

13. The cage rotor of claim 1, wherein the rotor cage comprises a braided net having rope strands formed from carbon nanotubes, wherein the net is wound around the rotor core.

14. The cage rotor of claim 1, wherein the rotor cage comprises a textile mat formed of fibers of carbon nanotubes, wherein each textile mat includes cutouts and is wound around the rotor core.

15. An electric machine, comprising:
a cage rotor comprising:
a rotor core; and
an electrically conductive rotor cage arranged around the rotor core;
wherein the rotor cage comprises fibers spun from a plurality of carbon nanotubes; and
wherein the rotor cage comprises at least one element woven from fibers including carbon nanotubes or at least one rope strand formed from fibers including carbon nanotubes.

16. The electric machine of claim 15, wherein the rotor cage of the cage rotor comprises a plurality of longitudinal rods and two end-side connecting structures,
wherein each end-side connection structure joins at least some of the longitudinal rods to one another in an electrically conductive manner.

17. The electric machine of claim 15, wherein the rotor cage of the cage rotor comprises a plurality of rope strands formed from carbon nanotubes.

18. The electric machine of claim 15, wherein the rotor cage of the cage rotor has a plurality of longitudinal rods and two end-side connecting structures,
wherein at least some of the rope strands extend over some of the longitudinal rods and over at least one connecting structure.

19. The electric machine of claim 18, wherein the rotor cage of the cage rotor has a plurality of longitudinal rods and two end-side connecting structures,
wherein the longitudinal rods and the connecting structures are linked to one another by knots in the rope strands.

20. The electric machine of claim 15, wherein the rotor core of the cage rotor comprises a soft magnetic material.
